(19) United States
(12) Patent Application Publication
(10) Pub. No.: US 2025/0071079 A1
(43) Pub. Date: Feb. 27, 2025

(54) COMMENT DISPLAY METHOD AND ELECTRONIC DEVICE

(71) Applicant: Beijing Dajia Internet Information Technology Co., Ltd., Beijing (CN)

(72) Inventors: Liangjun Gao, Beijing (CN); Qiu Yang, Beijing (CN); Yayun Zuo, Beijing (CN)

(21) Appl. No.: 18/747,313

(22) Filed: Jun. 18, 2024

(30) Foreign Application Priority Data
Aug. 21, 2023 (CN) 202311055996.1

(51) Int. Cl. H04L 51/212; G06F 40/205; G06F 40/279; G06F 40/30; H04L 51/216

(52) U.S. Cl. CPC H04L 51/212; G06F 40/205; G06F 40/279; G06F 40/30; H04L 51/216

(57) ABSTRACT

A comment display method includes: displaying a comment display area of a video work, where a plurality of comments on the video work are displayed in the comment display area; displaying a newly-added first category label in the comment display area in response to a label adding operation; and blocking comments that do not belong to a first category from the comment display area, where the first category is a category represented by the first category label.

This application is based on and claims priority to Chinese Patent Application No. 202311055996.1, filed on Aug. 21, 2023, the disclosure of which is herein incorporated by reference in its entirety.

### TECHNICAL FIELD

The present disclosure relates to the field of computer technologies, and in particular relates to a comment display method and an electronic device.

### BACKGROUND

With the development of Internet technology, more users share video works created by themselves on video platforms. Accordingly, it has gradually become a way of interaction among users to view or reply to comments from other users in the comment area of the video work.

### SUMMARY

The present disclosure provides a comment display method and an electronic device. The technical solutions are as follows.

According to an aspect of the embodiments of the present disclosure, a comment display method is provided. The comment display method includes:
displaying a comment display area of a video work, where a plurality of comments on the video work are displayed in the comment display area;
displaying a newly-added first category label in the comment display area in response to a label adding operation; and
blocking comments that do not belong to a first category from the comment display area, where the first category is a category represented by the first category label.

According to another aspect of the embodiments of the present disclosure, an electronic device is provided. The electronic device includes:
one or more processors; and
a memory configured to store program codes executable by the one or more processors;
where the one or more processors are configured to execute the program codes to:
display a comment display area of a video work, where a plurality of comments on the video work are displayed in the comment display area;
display a newly-added first category label in the comment display area in response to a label adding operation; and
block comments that do not belong to a first category from the comment display area, where the first category is a category represented by the first category label.

According to still another aspect of the embodiments of the present disclosure, a non-transitory computer-readable storage medium comprising instructions is provided. The instructions, when executed by a processor of an electronic device, cause the electronic device to:
display a comment display area of a video work, where a plurality of comments on the video work are displayed in the comment display area;
display a newly-added first category label in the comment display area in response to a label adding operation; and
block comments that do not belong to a first category from the comment display area, where the first category is a category represented by the first category label.

### BRIEF DESCRIPTION OF DRAWINGS

FIG. 1 is a schematic diagram of an implementation environment according to an embodiment of the present disclosure;

FIG. 2 is a flowchart of a comment display method according to an embodiment of the present disclosure;

FIG. 3 is a flowchart of another comment display method according to an embodiment of the present disclosure;

FIG. 4 is a schematic diagram of a video playback interface according to an embodiment of the present disclosure;

FIG. 5 is a schematic diagram of another video playback interface according to an embodiment of the present disclosure;

FIG. 6 is a schematic diagram of a label adding interface according to an embodiment of the present disclosure;

FIG. 7 is a flowchart of adding a first category label according to an embodiment of the present disclosure;

FIG. 8 is an another flowchart of adding a first category label according to an embodiment of the present disclosure;

FIG. 9 is a schematic diagram of a label creation pop-up window according to an embodiment of the present disclosure;

FIG. 10 is a schematic diagram of a target display style according to an embodiment of the present disclosure;

FIG. 11 is a schematic diagram of a comment display area according to an embodiment of the present disclosure;

FIG. 12 is a schematic diagram of another comment display area according to an embodiment of the present disclosure;

FIG. 13 is a block diagram of a comment display apparatus according to an embodiment of the present disclosure;

FIG. 14 is a block diagram of another comment display apparatus according to an embodiment of the present disclosure; and

FIG. 15 is a block diagram of an electronic device according to an embodiment of the present disclosure.

### DETAILED DESCRIPTION

It should be noted that the information (including, but not limited to, user device information, user personal information, etc.), data (including, but not limited to, data used for analysis, stored data, displayed data, etc.), and signals involved in the present disclosure are all authorized by users or fully authorized by respective parties, and the collection, use and processing of the relevant data need to comply with relevant laws, regulations and standards of the respective countries and regions. For example, the category label and description information of the category label involved in the present disclosure are all obtained under full authorization.

In the case that a large number of comments are displayed in the comment area of a video work, since the comments vary in quality, users need to manually browse a large number of comments to find the ones they are interested in, resulting in a higher cost for users to view the comments and lower human-computer interaction efficiency. Therefore, how to display comments so that users can quickly view the comments they are interested in is a technical problem that needs to be solved.

Embodiments of the present disclosure provide a comment display method. According to this method, users are allowed to add category labels in the comment area of a video work on their own during the process of browsing the video work and commenting on the video work, and a terminal displays the category labels added by the users in the comment area. In the case that a category label is successfully added, the terminal determines and displays comments belonging to the category represented by the category label, and the users can view the comments belonging to the category in the comment area, i.e., view the comments that the users are interested in without manually browsing the comments, thereby reducing the user's cost of viewing the comments and improving the human-computer interaction efficiency.

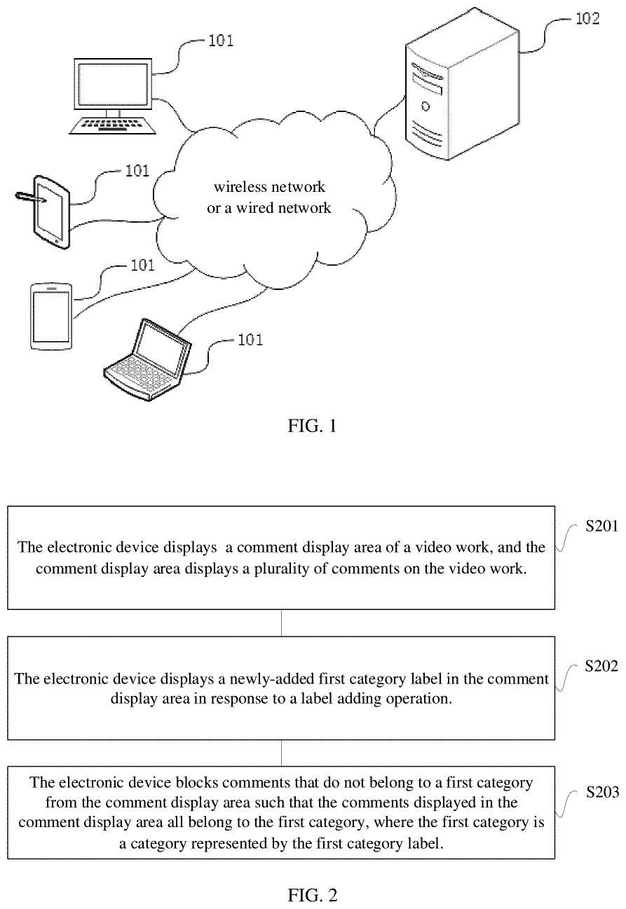

FIG. 1 is a schematic diagram of an implementation environment of a comment display method according to an embodiment. Referring to FIG. 1, the implementation environment specifically includes a terminal 101 and a server 102. The terminal 101 is connected to the server 102 via a wireless network or a wired network.

The terminal 101 is at least one of a smartphone, a smartwatch, a desktop computer, a handheld computer, a moving picture experts group audio layer III (MP3) player, a moving picture experts group audio layer IV (MP4) player and a laptop computer. A video application is installed and runs in the terminal 101, and a user logs into the video application and uses the terminal 101 to browse a video work through the application. The user can view other users' comments on the video work in the comment area of the video work. The server 102 is a backend server of the application, and the server 102 is configured to provide backend services for the application.

The terminal 101 generally refers to one of a plurality of terminals, and the embodiments of the present disclosure are illustrated by taking the terminal 101 as an example. A person skilled in the art will know that more or fewer terminals may be provided. For example, several terminals are provided, or dozens of terminals, hundreds of terminals, or more terminals are provided. The number and device type of the terminals are not limited in the embodiments of the present disclosure.

The server 102 is at least one of a server, a plurality of servers, a cloud computing platform, and a virtualization center. In some embodiments, more or fewer of the servers are provided, which is not limited in the embodiments of the present disclosure. Certainly, the server 102 may also include servers having other functions to provide more comprehensive and diverse services. In some embodiments, the server 102 undertakes the primary computing work and the terminal 101 undertakes the secondary computing work; or, the server 102 undertakes the secondary computing work and the terminal 101 undertakes the primary computing work; or, the server 102 and the terminal 101 carry out collaborative computing by a distributed computing architecture. The server 102 is connected to the terminal 101 and other terminals via a wireless network or a wired network.

FIG. 2 is a flowchart of a comment display method according to an embodiment of the present disclosure. Referring to FIG. 2, the method is implemented by an electronic device and includes the following steps.

In S201, the electronic device displays a video playback interface, where the video playback interface displays a video work and a comment display area, and the comment display area displays a plurality of comments on the video work.

In the embodiments of the present disclosure, a video application is installed in the electronic device. The video application provides services such as video creation, video sharing, and video browsing. The user can log into the application by the electronic device and browse video works created by other users in the application. The terminal displays the comment display area while the user is browsing the video work, and the comment display area displays a plurality of comments on the video work. The user can post his/her own comments on the video work in the comment display area, and can also view the plurality of comments displayed in the comment display area.

In some embodiments, the electronic device displays a video playback interface, and the video playback interface displays the video work and the comment display area of the video work.

In the embodiments of the present disclosure, the user can log into the application by an electronic device and browse video works created by other users in the video playback interface of the application. When the user browses the video work, in response to the user's operation of viewing a comment or posting a comment, the terminal displays the comment display area, and a plurality of comments on the video work are displayed in the comment display area. The user can post his/her own comments on the video work in the comment display area, and view the plurality of comments displayed in the comment display area. For example, the video playback interface displays a comment control, and the comment control is configured to, upon being triggered, display the comment display area of a video work that is currently played. Accordingly, both the user's operation of viewing a comment and posting a comment may act as the user's trigger operation on the comment control.

In S202, the electronic device displays a newly-added first category label in the comment display area in response to a label adding operation.

One or more first category labels are displayed in the comment display area. Adding a category label refers to adding a category label which is not currently displayed to the comment display area, and the added first category label is a category label selected from preset category labels or category labels that have been added previously, or is a category label that is newly created based on a label name and label description information which are input.

In the embodiments of the present disclosure, during browsing a plurality of comments displayed in the comment display area, the user may be interested in certain specific categories of comments, such as comments expressing a supportive attitude, comments expressing an opposing attitude, comments posted by users in the same city, or comments posted by celebrities. Therefore, the user may add at least one category label to the comment display area by the electronic device, so as to screen out a particular category of comments by the category label. The category label is used to aggregate comments belonging to the same category. Accordingly, in response to the user's operation of adding the category label, the electronic device displays at least one category label that is newly added in the comment display area. The electronic device may display the category label on the top side, the bottom side, the left side or the right side of the comment display area, and the display position of the category label is not limited in the embodiments of the present disclosure.

For example, the electronic device displays three category labels, i.e., “Support”, “Oppose”, and “Same city” on the top side of the comment display area. The above three category labels are used to aggregate comments expressing a supportive attitude, comments expressing an opposing attitude, and comments posted by users in the same city, respectively.

In some embodiments, the electronic device can also process the plurality of comments on the video work by an artificial intelligence algorithm, to automatically generate a plurality of category labels and display the plurality of category labels in the comment display area. The category of the comments aggregated by each category label is obtained by the electronic device through analyzing the content of the plurality of comments by the artificial intelligence algorithm. The category labels may be generated by the artificial intelligence algorithm, and may also be added by users on their own. For ease of description, the category label added by the users on their own is hereinafter referred to as a first category label.

In S203, the electronic device blocks comments that do not belong to a first category from the comment display area, where the first category is a category represented by the first category label.

One or more comments belonging to the first category are displayed in the comment display area. The electronic device blocks the comments that do not belong to the first category from the comment display area, so that the comments displayed in the comment display area all belong to the first category.

In the embodiments of the present disclosure, the user can add category labels by the electronic device. In response to a successful addition of the first category label, which is equivalent to receiving an instruction to block the comments that do not belong to the first category, the electronic device can automatically block the comments that do not belong to the first category from the comment display area so that only the comments that belong to the first category are displayed in the comment display area.

In the embodiments of the present disclosure, after the user has successfully added at least one first category label by the electronic device, the user can trigger any first category label to display the comments that belong to the category represented by the first category label in the comment display area. Accordingly, for any first category label, in response to the user's trigger operation on the first category label, the electronic device blocks the comments that do not belong to the category from the comment display area based on the category represented by the first category label, so that the comments displayed in the comment display area are all comments that belong to the category. The electronic device may block comments by canceling the display of the comments, and may also block comments by removing the comments. The way of blocking the comments is not limited in the embodiments of the present disclosure.

For example, in response to the user's trigger operation on the category label “Support”, the electronic device blocks the comments that do not belong to the category “expressing a supportive attitude” from the comment display area, so that the comments displayed in the comment display area are all comments expressing a supportive attitude.

Thus, it can support the user in categorizing comments according to his/her own interests and preferences by allowing the user to add personalized category labels on his/her own. In response to the user's trigger operation on any category label that the user is interested in, the electronic device displays the comments that belong to the category label in the comment display area, which not only satisfies the user's need to view the comments according to the category, but also enhances the user's sense of identity with the comment categorization result.

The embodiments of the present disclosure provide a comment display method. According to this method, a user is allowed to add a category label in the comment area of a video work on his/her own during the process of viewing the video work and commenting on the video work, and the terminal displays the category label added by the user in the comment area. In response to the user's trigger operation on any newly-added category label, the terminal determines and displays at least one comment that belongs to the category represented by the category label. Therefore, the user can view the comments that the user is interested in by adding and triggering the category label that the user is interested in, without manually browsing the comments, which reduces the user's cost of viewing the comments and improves the human-computer interaction efficiency.

In some embodiments, displaying the newly-added first category label in the comment display area in response to the label adding operation includes: displaying a label adding interface in response to the label adding operation, where the label adding interface displays a plurality of preset category labels and a plurality of history category labels, the preset category labels are category labels in a category label library that are not displayed in the comment display area, and the history category labels are category labels that have been added by a currently logged-in account; and displaying at least one category label as the first category label in the comment display area, in response to a selection operation on the at least one category label displayed on the label adding interface.

In the embodiments of the present disclosure, a plurality of preset category labels and a plurality of history category labels are displayed in the label adding interface for the user to select, and the user can add the first category label by the terminal and by performing an operation of selecting a label, which simplifies the user's operation of adding the category label on his/her own and improves the human-computer interaction efficiency.

In some embodiments, the label adding interface further displays a label creation area, and the label creation area is used to create a category label. The method further includes: acquiring a label name and label description information input in the label creation area in response to an input operation in the label creation area, where the label description information describes the category label to be created; and displaying a first category label having a name of the label name and matching the label description information in the comment display area based on the label name and the label description information.

In the embodiments of the present disclosure, it can support the user in creating a personalized category label in the label creation area by displaying the label creation area in the label adding interface such that the user can create the category label that the user is interested in on his/her own, thereby better satisfying the user's personalized needs.

In some embodiments, blocking the comments that do not belong to the first category from the comment display area includes: semantically recognizing the label name and the label description information to acquire the first category; determining a plurality of first comments from the plurality of comments displayed in the comment display area based on the first category, where the first comment belongs to the first category; and blocking comments other than the plurality of first comments from the comment display area.

In the embodiments of the present disclosure, by semantically recognizing the label name and the label description information input by the user, the user's intention to create the first category label can be determined more accurately based on a semantic recognition result, that is, the category of the comments to be aggregated by the first category label described by the label name and the label description information is determined, so as to facilitate the terminal to determine the category represented by the first category label more accurately.

In some embodiments, blocking the comments that do not belong to the first category from the comment display area includes: in response to a trigger operation on any one of the first category labels, displaying a plurality of keywords in the comment display area based on the label name of the first category label; determining a second comment from the plurality of comments displayed in the comment display area in response to a selection operation on at least one keyword, where a correlation degree between the second comment and the at least one keyword is greater than a correlation degree threshold; and blocking comments other than the second comment from the comment display area.

In the embodiments of the present disclosure, by presenting a plurality of keywords to the user, the user can determine the standard for screening the comments according to his/her own interests and preferences. According to the above method, in the case that the user is not interested in a certain keyword, the terminal does not display comments related to the keyword in the comment display area if the user does not select the keyword, even if the terminal acquires the keyword through semantic recognition, thereby better satisfying the user's demand for comment categorization, and enhancing the user's sense of identity with the comment categorization result.

In some embodiments, blocking the comments that do not belong to the first category from the comment display area includes: in response to a trigger operation on the first category label, determining a third comment from the plurality of comments displayed in the comment display area based on a history comment associated with the first category label in the case that the first category label is the preset category label or the history category label, where the history comment is a comment belonging to the first category in a comment display area of other video works, and a similarity between the third comment and the history comment is greater than a similarity threshold; and blocking comments other than the third comment from the comment display area.

In the embodiments of the present disclosure, by screening the plurality of comments currently displayed in the comment display area based on the history comment associated with the first category label, the comments having a higher correlation degree with the first category label can be screened out accurately, thereby improving the accuracy of the comment categorization result.

In some embodiments, the method further includes: updating a type of the first category label from a private label type to a public label type in the case that the number of target accounts is greater than a number threshold, where the target accounts are accounts that have added the first category label in the comment display area, and the category label of the public label type indicates that the category label is visible to all accounts viewing the video work.

In the embodiments of the present disclosure, by updating the type of the first category label which is added by a large number of users from the private label type to the public label type, the category label with a higher user recognition degree can be displayed to a larger number of users, thereby increasing the recognition degree of the comment categorization result by more users.

In some embodiments, the method further includes: displaying at least one of avatars or usernames of the target accounts in a target display style in response to the type of the first category label being updated to the public label type, where the target display style is configured to indicate that the category labels added by the target accounts are updated to the public label type.

In the embodiments of the present disclosure, in the case that the type of the first category label is updated to the public label type, when the user participates in the addition of a higher-quality category label, a positive feedback can be provided to the user by displaying the user account that has added the category label in the target display style, thereby motivating the user to add higher-quality category labels.

In some embodiments, the method further includes: for any comment on the video work, preprocessing the comment to acquire a preprocessed comment, where the preprocessing is to remove punctuation, special symbols, and blank symbols from the comment; performing a word segmentation on the preprocessed comment to acquire a word segmentation result, where the word segmentation result includes a plurality of keywords appearing in the preprocessed comment; performing a sentiment polarity analysis on the preprocessed comment to acquire a sentiment polarity of the comment, where the sentiment polarity is positive, negative or neutral; and categorizing the comment based on the word segmentation result and the sentiment polarity of the comment to acquire a category of the comment.

In the embodiments of the present disclosure, the special symbols, sensitive information and blank symbol noise in the comment can be efficiently removed by performing preprocessing with low complexity on the comment. Moreover, by performing a word segmentation and sentiment analysis on the preprocessed comment, the category of the comment can be determined more accurately based on the word segmentation result and the sentiment polarity of the comment.

In some embodiments, the method further includes: determining a comment belonging to a second category from the plurality of comments on the video work in response to a trigger operation on a second category label displayed in the comment display area; and displaying the comment belonging to the second category in the comment display area, where the second category label is any category label displayed in the comment display area, and the second category is a category represented by the second category label.

In the embodiments of the present disclosure, according to the above method, the user can select the category label that the user is interested in from the comment display area, and the terminal screens comments and displays the comment belonging to the category label for the user, without the need for the user to manually browsing the comments, which reduces the user's cost of viewing the comments that the user is interested in and improves the human-computer interaction efficiency.

In some embodiments, displaying the comment belonging to the second category in the comment display area includes: determining a display style associated with the second category label in response to the trigger operation on the second category label; and displaying the comment belonging to the second category in the comment display area in the display style associated with the second category label.

In the embodiments of the present disclosure, by displaying the comment display area and a plurality of comments in the display style associated with the category label, the terminal can show the comment display areas of different display styles in the case that the user switches the category label, which improves the interactivity and interestingness of the interaction.

In some embodiments, the method further includes: adjusting a display order of category labels in a comment display area of a next video work based on an interaction of a currently logged-in account with each of the category labels displayed in the comment display area, where the interaction is an interaction with a comment belonging to the category represented by the category label.

In the embodiments of the present disclosure, by counting the interactions of the user account with the category labels and adjusting the display order of category labels in the comment display area of another video work based on the interactions, the comment categorization results can be continuously optimized based on user feedback, and the category labels that better meet users' expectations can be shown to the users.

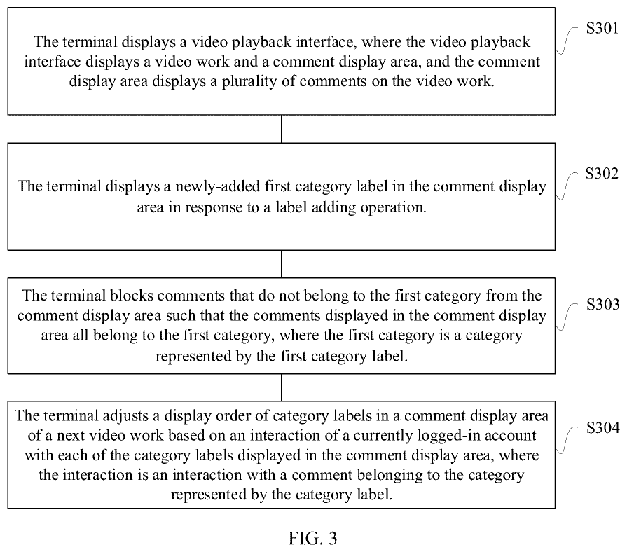

The above FIG. 2 shows a comment display process in the present disclosure. The comment display solutions provided in the present disclosure are illustrated in further detail below. FIG. 3 is a flowchart of another comment display method according to an embodiment of the present disclosure. This method is illustrated by taking the method being executed by a terminal as an example. Referring to FIG. 3, the method includes the followings.

In S301, the terminal displays a video playback interface, where the video playback interface displays a video work and a comment display area, and the comment display area displays a plurality of comments on the video work.

In the embodiments of the present disclosure, a video application is installed in the electronic device. The application provides services such as video creation, video sharing, and video browsing. The user can log into the application by the electronic device and browse video works created by other users in the application. While the user is browsing the video work, the terminal displays the comment display area on the video playback interface in response to the user's operation of viewing a comment or posting a comment. A plurality of comments on the video work are displayed in the comment display area. The user can post his/her own comments on the video work in the comment display area, and can also view the plurality of comments displayed in the comment display area.

The video playback interface further displays a comment control, and the comment control is configured to, upon being triggered, display the comment display area of a video work that is currently played on the video playback interface. Accordingly, the user's operation of viewing a comment or posting a comment may act as the user's trigger operation on the comment control.

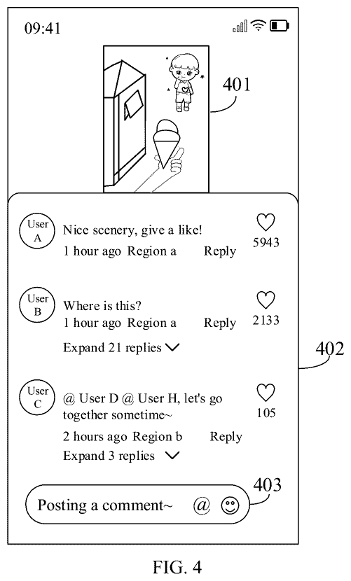

For example, FIG. 4 shows a schematic diagram of a video playback interface. As shown in FIG. 4, the video playback interface displays a video picture 401 of a video work, a comment display area 402, and a comment-posting control 403. The comment display area 402 displays comments posted by user A, user B, and user C on the video work. Users can edit and post comments on the video work by triggering the comment-posting control 403.

It is to be noted that the embodiments of the present disclosure are illustrated by taking the video playback interface displaying the video work and the comment display area as an example. In some other embodiments, the comment display area of the video work is displayed in other ways, instead of executing the above step S301.

In S302, the terminal displays a newly-added first category label in the comment display area in response to a label adding operation.

In the embodiments of the present disclosure, during browsing a plurality of comments displayed in the comment display area, the user may be interested in certain specific categories of comments, such as comments expressing a supportive attitude, comments expressing an opposing attitude, comments posted by users in the same city, or comments posted by celebrities. Therefore, the user can add at least one category label to the comment display area by the electronic device, so as to screen out a particular category of comments by the category label. The category label is used to aggregate comments belonging to the same category. Accordingly, in response to the user's operation of adding the category label, the electronic device displays at least one category label that is newly added in the comment display area. The electronic device can display the category label on the top side, the bottom side, the left side or the right side of the comment display area, and the display position of the category label is not limited in the embodiments of the present disclosure.

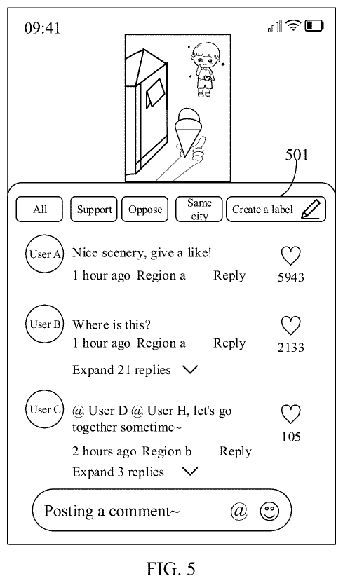

For example, FIG. 5 shows a schematic diagram of another video playback interface. As shown in FIG. 5, the electronic device displays four category labels: “All”, “Support”, “Oppose”, and “Same city” on the top side of the comment display area. The “All” category label is used to aggregate all the comments on a video work. The “Support”, “Oppose”, and “Same city” category labels are used to aggregate comments expressing a supportive attitude, comments expressing an opposing attitude, and comments posted by users in the same city, respectively.

In some embodiments, the electronic device can process the plurality of comments on the video work by the artificial intelligence algorithm, to automatically generate a plurality of category labels and display the plurality of category labels in the comment display area. The category of the comments aggregated by each category label is acquired by the electronic device through analyzing the content of the plurality of comments by the artificial intelligence algorithm. For any video work, the electronic device collects a plurality of comments on the video work. After performing at least one of preprocessing of noise removal, word segmentation, sentiment polarity analysis, semantic analysis and the like on the plurality of comments by the natural language processing (NLP) technology, the electronic device processes the texts of the preprocessed comments by the artificial intelligence algorithm to acquire the category of each of the plurality of comments. Then, the electronic device aggregates the categories of the plurality of comments to acquire a plurality of category labels, and displays the plurality of category labels in the comment display area. For example, if the categories of the comments on the video work acquired by the electronic device by the artificial intelligence algorithm include three categories of “comments introducing locations of attractions”, “comments introducing tourist tips”, and “comments introducing prices of tickets”, the electronic device generates three category labels “location”, “tips”, and “ticket”, and displays the above three category labels in the comment display area for the users to view.

Therefore, the category labels displayed in the comment display area can be generated by the artificial intelligence algorithm and can also be added by the users on their own. For ease of description, the category label added by the users is referred to as the first category label. The process of adding the first category label by the users through the terminal is described in the following two ways.

The first way: the terminal provides the user with a number of preset category labels or a number of history category labels that have been added by the user, from which the user selects the first category label to be added this time. In response to the label adding operation, the terminal displays a label adding interface. The label adding interface displays a plurality of preset category labels and a plurality of history category labels. The preset category labels are category labels in the category label library that are not displayed in the comment display area. The category label library includes a plurality of preset category labels. The preset category labels are category labels that may be preset by technicians based on experience, such as category labels “food”, “scenery”, and “commentary”. The history category labels are category labels that have been added by the currently logged-in account. In response to the user's selection operation to at least one category label displayed in the label adding interface, the terminal takes the at least one category label as the first category label and displays it in the comment display area. By displaying a plurality of preset category labels and a plurality of history category labels in the label adding interface for the user to select, the user can add the first category label by selecting a label through the terminal, which simplifies the user's operation of adding the category label on his/her own, and improves the human-computer interaction efficiency.

It is to be noted that, in the case that the terminal adds the category label in the above first way, the terminal may aggregate the comments in advance and may also aggregate the comments in real time. Aggregating the comments in advance means that before the user adds the first category label by the terminal, the terminal aggregates a plurality of comments on the video work based on the plurality of preset category labels or the plurality of history category labels that have been added by the user, respectively, to acquire the comments aggregated under each category label. The comments aggregated under a certain category label all belong to the category represented by the category label. Therefore, in response to the user's successful addition of at least one first category label by the terminal, the terminal can not only display the newly-added first category label in the comment display area, but also directly display at least one comment aggregated under the first category label. Aggregating the comments in real time means that after the user successfully adds at least one first category label, the terminal aggregates a plurality of comments on the video work based on the newly-added first category label to acquire the comments aggregated under the first category label. The opportunity of aggregating the comments by the terminal based on the category label is not limited in the embodiments of the present disclosure.

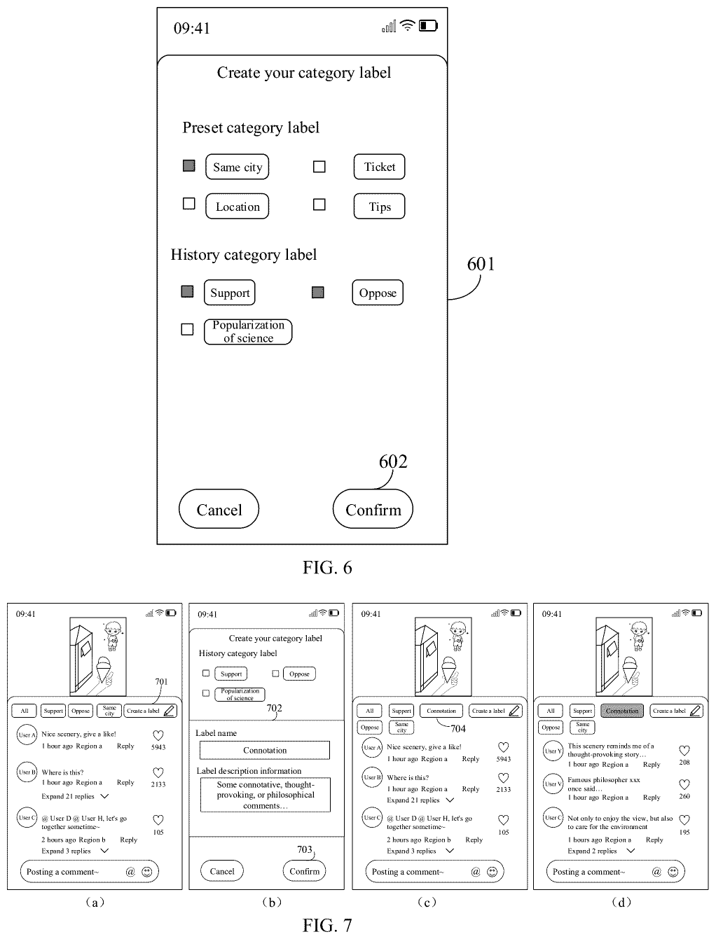

As shown in FIG. 5, a label adding control 501 is further displayed in the comment display area. The user's label adding operation is the user's trigger operation on the label adding control 501. In response to the user's trigger operation on the label adding control 501, the terminal displays a label adding interface as shown in FIG. 6. As shown in FIG. 6, the label adding interface 601 displays four preset category labels: “same city”, “ticket”, “location” and “tips”; and the label adding interface 601 also displays three history category labels: “Support”, “Oppose”, and “Popularization of science”. After the user selects the three category labels “Support”, “Oppose” and “Same city”, in response to the user's trigger operation on the confirm control 602, the terminal adds three first category labels “Support”, “Oppose” and “Same city”, and displays the above three first category labels in the comment display area, that is, the terminal displays the video playback interface as shown in FIG. 5.

The second way: the terminal creates a category label for the user based on the label name input by the user. Accordingly, the label adding interface further displays a label creation area, and the label creation area is used to create a category label. In response to a user's input operation on the label creation area, the terminal acquires the label name and label description information input in the label creation area. The label description information is used to describe a category label to be created. The label description information is used to describe the category represented by the category label, or describe characteristics of the comments aggregated by the category label, such as “this category label is used to aggregate comments posted by users in the same city” or “this category label is used to aggregate comments posted by celebrity users”. The label description information is not limited in the embodiments of the present disclosure. Then, the terminal creates a first category label having a name of the label name and matching the label description information based on the label name and the label description information, and displays the first category label in the comment display area. The first category label matching the label description information means that the category represented by the first category label is the category described by the label description information.

In the embodiments of the present disclosure it can support the user in creating a personalized category label in the label creation area by displaying the label creation area in the label adding interface, such that the user can create the category label that the user is interested in on his/her own, thereby better satisfying the user's personalized needs.

It is to be noted that, in the case that the terminal creates the category label in the above second way, the terminal aggregates a plurality of comments on the video work in the above way of aggregating comments in real time based on the newly-created first category label.

In some embodiments, after the user creates the first category label, the user can view a plurality of comments belonging to the first category label in the comment display area by triggering the first category label. Accordingly, in response to the user's trigger operation on the first category label, the terminal blocks comments that do not belong to the first category from the comment display area. For example, FIG. 7 shows a flowchart of adding a first category label. As shown in (a) of FIG. 7, the video playback interface displays a label creation control 701. In response to the user's trigger operation on the label creation control 701, the terminal displays the label adding interface shown in (b) of FIG. 7. The label adding interface displays a label creation area 702, and an input box for the label name and an input box for the label description information are displayed in the label creation area 702. The user may input the name of the first category label to be created into the input box for the label name, and input the label description information of the first category label to be created into the input box for the label description information. In response to the user's trigger operation on the confirm control 703, the terminal acquires the label name and the label description information input by the user in the label creation area 702, and then the terminals create a first category label having a name of “Connotation” based on the label name and the label description information and displays the first category label in the comment display area, that is, the terminal displays the video playback interface shown in (c) of FIG. 7. The video playback interface displays the first category label 704 of “Connotation” created by the user. The user can view a plurality of comments belonging to the category represented by the first category label in the comment display area by triggering the first category label 704 of “Connotation”. Accordingly, in response to the user's trigger operation on the first category label 704 of “Connotation”, the terminal displays the video playback interface shown in (d) of FIG. 7. A plurality of comments belonging to the first category are displayed in the comment display area of the video playback interface, and the first category is a category represented by the first category label “Connotation”.

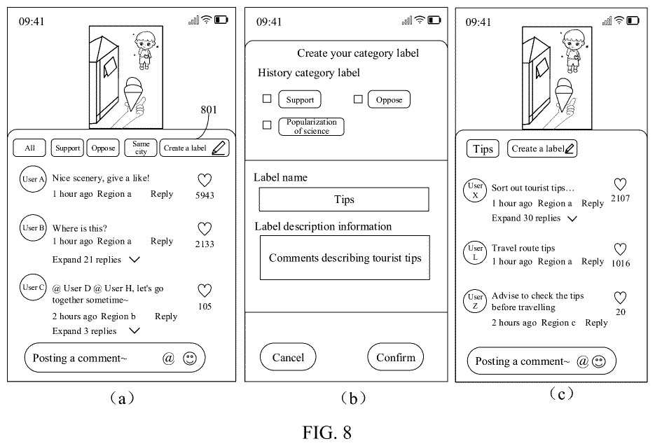

In some embodiments, after the user creates the first category label, the user can view a plurality of comments belonging to the category represented by the first category label in the comment display area, without the need to trigger the first category label. Accordingly, the terminal displays the first category label in the comment display area and blocks other category labels in response to the successful creation of the first category label. Moreover, the terminal blocks comments that do not belong to the first category from the comment display area. For example, FIG. 8 shows another flowchart of adding a first category label. In response to a user's trigger operation on the label creation control 801 in the video playback interface shown in (a) of FIG. 8, the terminal displays the label adding interface shown in (b) of FIG. 8. In response to the user's successful creation of the first category label “tips” in the label adding interface through the terminal, the terminal displays the video playback interface shown in (c) of FIG. 8. The video playback interface displays the newly-created first category label “tips”, which indicates that the user has successfully created the first category label having the label name of “tips”, and a plurality of comments describing the tourist tips are displayed in the comment display area of the video playback interface.

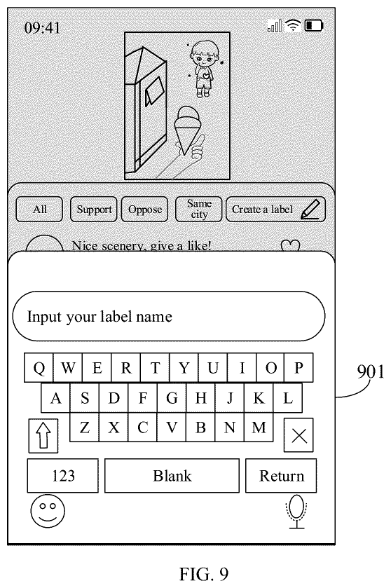

In some embodiments, in response to the user's trigger operation on the label creation control in the comment display area, the terminal may not display the label adding interface, but directly display a label creation pop-up window as shown in FIG. 9 in the video playback interface. The user can input the label name of the first category label to be created into the label creation pop-up window 901. Accordingly, the terminal creates the first category label based on the label name input by the user in the label creation pop-up window.

It should be noted that before the user adds the first category label by the terminal, a plurality of category labels generated by artificial intelligence may have already been displayed in the comment display area of the video playback interface. Therefore, in response to the user's successful addition of the first category label by the terminal, the terminal may display the newly-added first category label around the plurality of category labels above, such as below the plurality of category labels, on the right of the plurality of category labels, and the like. Furthermore, it is possible that the user adds the first category label because the user is not interested in the plurality of category labels that have been are displayed. Therefore, in response to user's successful addition of the first category label by the terminal, the terminal can also display the newly-added first category label in the comment display area, and block the plurality of category labels above.

In some embodiments, since the first category label is a category label added by the user on his/her own, the type of the first category label is by default a private label type. The private label type means that the category label of this type is only visible to the user who added it and is not visible to other users who view the video work. Therefore, in the case that a large number of users add the first category label, the terminal updates the type of the first category label to a public label type, so that the category label is visible to all of the other users who view the video work. Alternatively, in the case that the value of the first category label is high, the terminal may also update the type of the first category label to a public label type. The value of the first category label may be subjectively determined by technicians, or may be determined by the terminal based on the information amount of the comments aggregated by the first category label, which is not limited in the embodiments of the present disclosure. For any first category label displayed in the comment display area, the terminal determines the number of target accounts that have added the first category label in the comment display area. In the case that the terminal determines that the number of the target accounts is greater than a number threshold, the terminal updates the type of the first category label from the private label type to the public label type, so that the first category label is visible to all user accounts viewing the video work. The number threshold is a preset numerical value, such as 100, 200 and 300, which is not limited in the embodiments of the present disclosure. By updating the type of the first category label which has been added by a large number of users from the private label type to the public label type, the category label with a higher user recognition degree can be displayed to a larger number of users, thereby increasing the recognition degree of the comment categorization result by more users.

In some embodiments, in the case that the type of the first category label added by the user is updated to the public label type, the user is rewarded accordingly. For example, in response to the type of the first category label being updated to the public label type, the terminal displays at least one of an avatar or a username of the target account in a target display style. The target display style indicates that the category label added by the target account is updated to the public label type. The target display style may be an avatar frame or an avatar pendant. The target display style may also highlight the username, such as bolding the username, changing a color of the username, and changing a font of the username. The target display style is not limited in the embodiments of the present disclosure. In the case that the target account posts comments in the comment display area, the terminal displays the target account in the target display style in the comment display area. In the case that the target account does not post comments in the comment display area, the terminal displays the target account in the target display style on the home page of the target account.

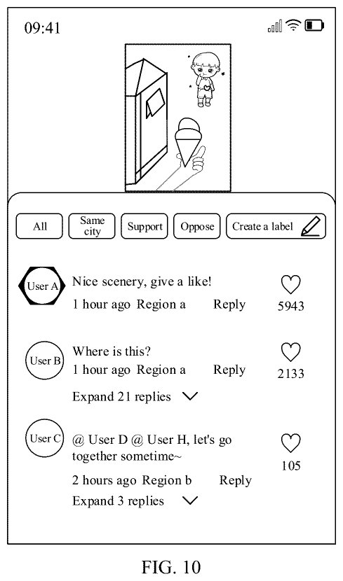

For example, FIG. 10 shows a schematic diagram of a target display style. As shown in FIG. 10, the user A is a user account adding the first category label “Support”. In the case that the type of the first category label “Support” is updated to the public label type, the terminal displays an avatar frame as shown in FIG. 10 on the avatar of the user A in the comment display area. In the case that the type of the first category label is updated to the public label type, when the user adds category labels of high quality, a positive feedback can be provided to the user by displaying the user account that has added the category label in the target display style, thereby motivating the user to add higher-quality category labels.

In S303, the terminal blocks comments that do not belong to the first category from the comment display area so that the comments displayed in the comment display area all belong to the first category, where the first category is a category represented by the first category label.

In the embodiments of the present disclosure, after the user successfully creates the first category label by the terminal, the terminal determines the category represented by the first category label, i.e., determines the first category. Then, the terminal determines comments that do not belong to the first category from the plurality of comments displayed in the comment display area, and blocks the comments that do not belong to the first category from the comment display area, based on the first category.

In some embodiments, the process of automatically blocking the comments in the case of successful addition of the first category label includes: in the case that one first category label has been successfully added, the terminal determines the category represented by the first category label, that is, determines the first category, and blocks the comments that do not belong to the first category from the comment display area, such that the comments displayed in the comment display area all belong to the first category; or, in the case that a plurality of first category labels have been successfully added, the terminal determines the category represented by each of the plurality of first category labels, that is, determines each first category, and blocks the comments that do not belong to each first category from the comment display area, such that any comment displayed in the comment display area belongs to any first category; or, in the case that a plurality of first category labels have been successfully added, the terminal determines the category represented by any first category label, that is, determines the first category, and blocks the comments that do not belong to the first category from the comment display area, such that the comments displayed in the comment display area belong to the first category. Any first category label is any one of the plurality of first category labels, and may be the first one or the last one of the plurality of first category labels.

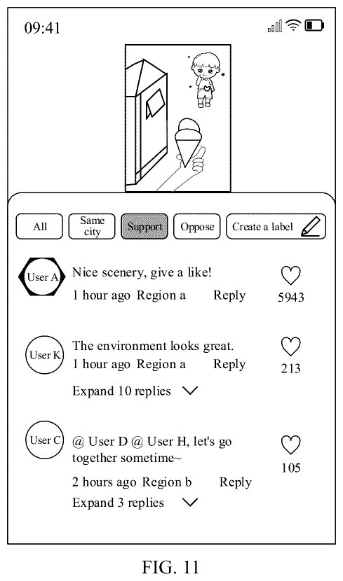

In the embodiments of the present disclosure, in response to the user's trigger operation on any first category label, the terminal blocks the comments that do not belong to the category from the comment display area based on the category represented by the first category label, so that the comments displayed in the comment display area all belong to this category. Therefore, by triggering any first category label displayed in the comment display area, the user can view the comments belonging to the category represented by the first category label in the comment display area. For example, FIG. 11 shows a schematic diagram of a comment display area. As shown in FIG. 11, in response to the user's trigger operation on the first category label “Support”, the terminal displays a plurality of comments belonging to the category “expressing a supportive attitude” in the comment display area.

By taking any first category label as an example, the process of determining the category of the first category label and blocking comments that do not belong to this category from the comment display area by the terminal based on the category of the first category label is described in the following steps (1)-(3).

(1) In the case that the first category label is a category label added by the terminal based on the label name input by the user, in response to a trigger operation on the first category label, the terminal semantically recognizes the label name and label description information of the first category label to acquire the category represented by the first category label, i.e., acquiring the first category. Then, the terminal determines a plurality of comments belonging to the first category from the plurality of comments displayed in the comment display area based on the first category. For ease of description, the comments belonging to the first category are referred to as the first comments. The terminal blocks the comments other than the first comments from the comment display area. By semantically recognizing the label name and label description information input by the user, the user's intention of adding the first category label can be determined accurately based on the semantic recognition result, i.e., determining the category of the comments to be aggregated by the first category label that is described by the label name and the label description information, such that the terminal can determine the category represented by the first category label more accurately.

There is one or more first comments. Before the terminal semantically recognizes the label name and the label description information, the terminal performs at least one of preprocessing of noise removal, word segmentation, part-of-speech (POS) tagging, and the like on the label name and the label description information. Then, the terminal semantically recognizes the preprocessed texts to acquire the semantic recognition result. The semantic recognition result may be a plurality of keywords. Accordingly, the terminal can identify the category represented by the first category label based on the plurality of keywords. For example, in the case that the name of the first category label is “Connotation” and the label description information of the first category label is “some connotative, thought-provoking, or philosophical comments”, the semantic recognition result acquired by the terminal through semantic recognition includes three keywords: “connotative”, “thought-provoking” and “philosophical”. Based on the three keywords, the terminal determines that the category represented by the first category label “Connotation” is at least one of “connotative comments”, “thought-provoking comments” and “philosophical comments”.

Furthermore, in the process that the terminal blocks a plurality of comments other than the first comment from the comment display area, the terminal may block the plurality of comments by canceling the display of these comments, and may also block the plurality of comments by removing these comments, and the way of blocking the comments is not limited in the embodiments of the present disclosure.

It is to be noted that, in the process that the terminal blocks the comments as described above, the terminal determines whether the comments belong to the first category based on the categories of the comments, and then determines whether to display the comments in the comment display area. Therefore, before blocking the comments, the terminal determines the category of each of the plurality of comments displayed in the comment display area. The process of determining the category of the comment by the terminal is described below in the following steps (1.1)-(1.4) by taking the first comment as an example.

(1.1) For any comment on a video work, the terminal preprocesses the comment to acquire a preprocessed comment. The preprocessing is used to remove punctuation, special symbols, and blank symbols in the comment. The terminal may also preprocess the comment to remove sensitive information such as sensitive words and offending words from the comment.

(1.2) The terminal performs a word segmentation on the preprocessed comment by a natural language processing technology to acquire a word segmentation result. The word segmentation result includes a plurality of keywords appearing in the preprocessed comment. The terminal may also perform POS tagging on the word segmentation result by the natural language processing technology, so as to determine the category of the comment based on the POS of the keyword.

(1.3) The terminal performs a sentiment polarity analysis on the preprocessed comment by a sentiment analysis algorithm to acquire the sentiment polarity of the comment. The sentiment polarity is positive, negative or neutral. In the case that the comment has a positive sentiment polarity, it represents that the attitude expressed by the comment tends to be positive or supportive; and in the case that the comment has a negative sentiment polarity, it represents that the attitude expressed by the comment tends to be negative or opposing.

The sentiment analysis algorithm may be a sentiment analysis model. The sentiment analysis model is configured to process input text data to acquire a sentiment label of the text data. The sentiment label is “positive”, “negative”, or “neutral”. The terminal processes the preprocessed comment by the sentiment analysis model to acquire the sentiment label of the comment, and determines the sentiment polarity of the comment based on the sentiment label.

In some embodiments, the terminal may also assess the quality of the comment through semantic analysis to filter out comments of poor quality, such as spam comments, inappropriate comments, and meaningless comments.

(1.4) The terminal categorizes the comment based on the word segmentation result and the sentiment polarity of the comment to acquire the category of the comment. The terminal can process the word segmentation result and the sentiment polarity of the comment through text mining and a keyword extraction algorithm to acquire the category of the comment. Alternatively, the terminal can also process the word segmentation result and the sentiment polarity of the comment by a text categorization model to acquire the category of the comment.

The special symbols, sensitive information and blank symbol noise in the comment can be efficiently removed by performing preprocessing with low complexity on the comment. Moreover, by performing a word segmentation and sentiment analysis on the preprocessed comment, the category of the comment can be determined more accurately based on the word segmentation result and the sentiment polarity of the comment.

In addition, for a voice comment on the video work, the terminal first converts the format of the comment from voice to text, and then performs the above processing on the comment in the text format to acquire the category of the voice comment.

Additionally, the terminal can determine the category of the comment based on account attributes of the user account which posts the comment. The account attributes of the user account include an IP address of the user account, an identity authentication mark of the user account, and the like. For example, the terminal determines at least one comment posted by a user account in the same city from the plurality of comments in the comment display area based on the IP address of the currently logged-in account, and determines the category of the comment as “comments posted by users in the same city”. The IP address of the user account in the same city and the IP address of the account currently logged in by the terminal belong to a same region. Alternatively, the terminal determines at least one comment posted by a user account that has been authenticated as a celebrity from the plurality of comments in the comment display area based on the identity authentication mark of the user account, and determines the category of the comment as “comments posted by celebrities”.

It is to be noted that, if a category of a comment is determined in the above manner, there may be a case that one comment belongs to more categories. For example, a comment may belong to “comments posted by users in the same city”, and may also belong to “comments expressing a supportive attitude”. The number of categories to which a comment belongs is not limited in the embodiments of the present disclosure.

The embodiments of the present disclosure are illustrated by taking the terminal executing the above steps as an example. The terminal categorizes the comments based on the user's local data, which can provide the user with a personalized comment categorization service while protecting the user's privacy. In some embodiments, the above steps may also be executed by a server, that is, the server determines the categories of the comments and returns the categories of the comments to the terminal. Then, the terminal blocks the comments as described above based on the categories of the comments. It can reduce the power consumption of the terminal and improve the efficiency of comment categorization to categorize the comments by the server.

(2) In the case that the first category label is a category label added in an arbitrary form, in response to a user's trigger operation on the first category label, the terminal can display a plurality of keywords in the comment display area based on the label name of the first category label. In response to the user's selection operation on at least one keyword, the terminal determines a plurality of comments whose correlation degree with the at least one keyword is greater than a correlation degree threshold from the plurality of comments displayed in the comment display area. For ease of description, the above type of comments are referred to as second comments. The terminal blocks the comments other than the second comments from the comment display area so that the comments displayed in the comment display area are all comments having a higher correlation degree with the keyword selected by the user. The correlation degree threshold is a preset percentage, such as 50%, 60%, or 70%, which is not limited in the embodiments of the present disclosure. By presenting the user with a plurality of keywords to select, the user can determine the standard for screening the comments according to his/her own interests and preferences. According to the above method, in the case that the user is not interested in a certain keyword, the terminal does not display comments related to the keyword in the comment display area if the user does not select the keyword, even if the terminal acquires the keyword through semantic recognition, thereby better satisfying the user's demand for comment categorization, and enhancing the user's sense of identity with the comment categorization result. Here, there is one or more second comments.

In addition, the terminal can determine a plurality of second comments based on the user's self-selected comments. In response to the user's trigger operation on the first category label, the terminal randomly selects a plurality of comments from the comments on the video work and displays the plurality of comments to the user. The user selects at least one comment belonging to the first category from the plurality of displayed comments according to his/her subjective feelings. Then, the terminal aggregates and categorizes the plurality of comments displayed in the comment display area based on the at least one comment selected by the user, thereby acquiring a plurality of second comments having a higher similarity degree to the plurality of comments selected by the user.

The terminal can determine the correlation degree between the comment and the keywords based on the number of keywords in the comment. For example, in the case that the user selects three keywords, for any comment, if there are three keywords in the comment, the terminal determines that the correlation degree between the comment and the three keywords is 100%; if there are two keywords in the comment, the terminal determines that the correlation degree between the comment and the three keywords is 80%; and if there is one keyword in the comment, the terminal determines that the correlation degree between the comment and the three keywords is 60%.

In addition, in the case that the first category label is a preset category label, the terminal determines a plurality of preset keywords associated with the preset category label, and displays the plurality of preset keywords in the comment display area for users to select. The preset keywords associated with the preset category label are set by a technician. In the case that the first category label is a history category label, the terminal determines a plurality of keywords associated with the history category label based on the label name and label description information of the history category label, and displays the plurality of keywords in the comment display area for users to select. The process of determining the plurality of keywords associated with the history category label by the terminal is the same as the process of determining the plurality of keywords indicated by the semantic recognition result by the terminal in the above step (1), and details are not repeated herein.

(3) In the case that the first category label is the preset category label or the history category label, in response to a user's trigger operation on the first category label, the terminal determines a plurality of comments, whose similarity with the history comments is greater than a similarity threshold, from the plurality of comments displayed in the comment display area based on history comments associated with the first category label. For ease of description, the above type of comments are referred to as third comments. The history comment is a comment belonging to the first category in the comment display area of other video work. The similarity between the third comment and the history comment is greater than the similarity threshold. The terminal blocks the comments other than the third comments from the comment display area. The similarity threshold is a preset percentage, such as 50%, 60%, or 70%, which is not limited in the embodiments of the present disclosure. By screening the plurality of comments displayed in the current comment display area based on the history comments associated with the first category label, the comments having a higher correlation degree with the first category label can be screened out more accurately, thereby improving the accuracy of the comment categorization result. Here, there is one or more third comments.

The terminal can determine the correlation degree between the comment and the history comment based on the number of matched words in the comment and the history comment. For example, for any comment, if there is one matched word in the comment and the history comment, the terminal determines that the similarity degree between the comment and the history comment is 60%; if there are two matched words in the comment and the history comment, the terminal determines that the similarity degree between the comment and the history comment is 80%; and if there are three matched words in the comment and the history comment, the terminal determines that the similarity degree between the comment and the history comment is 90%. In addition, the terminal can select a plurality of history comments associated with the first category label and determine the similarity degree between the comment and each of the plurality of history comments, respectively. Then, the terminal determines an average similarity degree between the comment and the plurality of history comments based on the similarity degree between the comment and each of the plurality of history comments and the number of history comments selected by the terminal. In the case that the average similarity degree is greater than the similarity threshold, the terminal determines that the comment is a third comment.

Additionally, a category label automatically generated by an artificial intelligence algorithm is also displayed in the comment display area. Therefore, a user can view the comments belonging to the category represented by the category label in the comment display area by triggering any category label displayed in the comment display area. The process of displaying the comments by the terminal in the comment display area is described below.

In some embodiments, in response to a user's trigger operation on a second category label displayed in the comment display area, the terminal determines a comment belonging to a second category from a plurality of comments on the video work. The second category label is any category label displayed in the comment display area, and the second category is a category represented by the second category label. The terminal then displays a comment belonging to the second category in the comment display area, such that the user can view the comments belonging to the second category in the comment display area. According to this method, the user can select the category label which the user is interested in from the comment display area, and the terminal screens comments and displays the comments belonging to this category label to the user, without the need for the user to manually browsing them, which reduces the user's cost of viewing the comments that the user is interested in and improves the human-computer interaction efficiency.

The second category label is any category label displayed in the comment display area, and the second category label is the same as or different from the first category label. In the case that the second category label is different from the first category label, the second category label is a category label other than the first category label in the comment display area.

In some embodiments, in the case that the second category label is the first category label, the second category is the first category. By triggering the second category label, only the comments belonging to the second category may be displayed in the comment display area.

For example, after the newly-added first category label is displayed in the comment display area in response to a label adding operation, the comments belonging to the second category are determined in the manner described above in response to a trigger operation on the second category label, that is, in response to a trigger operation on the first category label, and then only the comments belonging to the second category are displayed in the comment display area.

For another example, after the newly-added first category label is displayed in the comment display area in response to a label adding operation, the comments belonging to the second category are automatically determined, and only the comments belonging to the second category are displayed in the comment display area. Afterwards, the user may trigger another category label through the terminal, such that the comments belonging to the category represented by the another category label are displayed in the comment display area. In the case that the comments belonging to the another category are displayed, in response to a trigger operation on the second category label again, i.e., in response to a trigger operation on the first category label again, only the comments belonging to the second category are displayed in the comment display area in the manner described above.

In some embodiments, the second category label is different from the first category label, i.e., the second category label is a category label other than the first category label in the comment display area, and the second category is different from the first category. By triggering the second category label, only comments belonging to the second category are displayed in the comment display area. For example, in the case that only comments belonging to the first category are displayed in the comment display area, in response to a trigger operation on the second category label, only the comments belonging to the second category are displayed in the comment display area.

In some embodiments, the category label is also associated with a display style. In response to a user's trigger operation on the second category label, the terminal determines the display style associated with the second category label. The terminal then displays in the comment display area the comments belonging to the second category in the display style associated with the second category label. The display style associated with the second category label includes at least one of a background color of the comment display area, shading of the comment display area, a border of the comment display area, and a display style of a like control in the comment display area, which is not limited in the embodiments of the present disclosure. By displaying the comment display area and the plurality of comments in the display style associated with the second category label, the terminal can display the comment display region in different display styles in the case that the user switches the category label, thereby improving the interactivity and interestingness of the interaction.

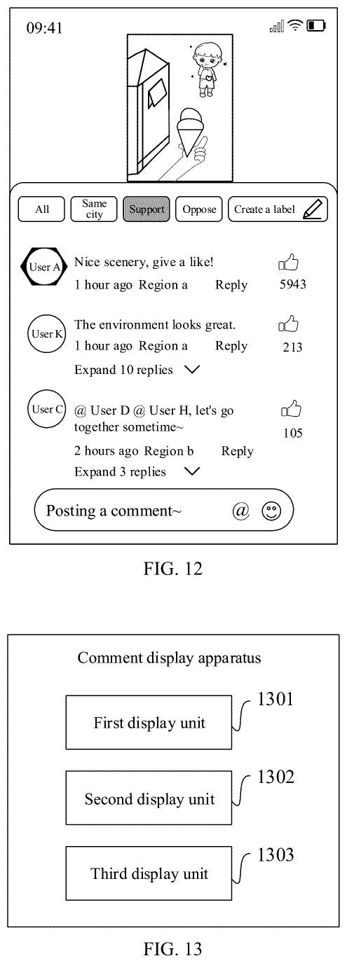

For example, FIG. 12 is a schematic diagram of another comment display area. As shown in FIG. 12, in response to the user's trigger operation on the category label “Support”, the terminal displays the comment display area as shown in FIG. 12. In the comment display area, the display style of the like control is changed from a heart icon to a like icon.

In S304, the terminal adjusts a display order of category labels in a comment display area of a next video work based on an interaction of a currently logged-in account with each of the category labels displayed in the comment display area. The interaction is an interaction with a comment belonging to the category represented by the category label.

In the embodiments of the present disclosure, after displaying a plurality of category labels in the comment display area, the terminal counts the interactions of the currently logged-in account with each of the category labels displayed in the comment display area. The interaction includes at least one of triggering any category label, giving a like to, replying to, favoriting and sharing the comments aggregated under the category label, and marking the comments aggregated under the category label as uninterested. Then, the terminal adjusts the category labels displayed in the comment display area of the next video work and the display order of the category labels based on the counted interactions. By counting the interactions between the user account and the category labels and adjusting the display order of the category labels in the comment display area of another video work based on the interactions, the comment categorization result can be continuously optimized according to the feedback from users, thereby displaying category labels that better meet users' expectations to the users.

For example, in the case that the interaction indicates that the user never triggers a certain category label, or rarely triggers the category label, or marks the comments under the category label with “not interested in” fora higher number of times, the terminal blocks the category label from the comment display area of the next video work. Alternatively, in the case that the interaction indicates that the user often triggers a certain category label, or gives a like to, replies to, favorites, or shares the comments under the category label for a higher number of times, the terminal prioritizes to display the category label in the comment display area of the next video work.

In some embodiments, the terminal can also determine the user's interaction preference based on the above counted interactions. Then, the terminal can categorize the plurality of comments on another video work based on the user's interaction preference. For example, when the user views other video works, the terminal screens out the comments belonging to the category for the user to view from the plurality of comments displayed in the comment display area of the another video work based on a category of the comments in which the user usually engages in interaction as indicated by the interaction preference.

The embodiments of the present disclosure provide a comment display method. According to this method, a user is allowed to add a category label in the comment area of a video work on his/her own during the process of viewing the video work and commenting on the video work, and the terminal displays the category label added by the user in the comment area. In response to a successful addition of a category label, the terminal determines and displays the comments belonging to the category represented by the category label. Therefore, the users can view the comments belonging to the category in the comment display area, i.e., view the comments the users are interested in, without manually browsing the comments, which reduces the user's cost of viewing the comments and improves the human-computer interaction efficiency.

All of the above optional technical solutions may be combined in any manner to form the optional embodiments of the present disclosure, and details are not repeated herein.

FIG. 13 is a block diagram of a comment display apparatus according to an embodiment of the present disclosure. As shown in FIG. 13, the apparatus includes: a first display unit 1301, a second display unit 1302 and a third display unit 1303.

The first display unit 1301 is configured to display a comment display area of a video work. A plurality of comments on the video work are displayed in the comment display area.

The second display unit 1302 is configured to display a newly-added first category label in the comment display area in response to a label adding operation.

The third display unit 1303 is configured to block comments that do not belong to a first category from the comment display area such that the comments displayed in the comment display area all belong to the first category. The first category is a category represented by the first category label.

In some embodiments, the second display unit 1302 is configured to: display a label adding interface in response to the label adding operation, where the label adding interface displays a plurality of preset category labels and a plurality of history category labels, the preset category labels are category labels in a category label library that are not displayed in the comment display area, and the history category labels are category labels that have been added by a currently logged-in account; and display the at least one category label as the first category label in the comment display area, in response to a selection operation on at least one category label displayed on the label adding interface.

In some embodiments, the label adding interface further displays a label creation area which is used to create a category label.

The second display unit 1302 is further configured to: acquire a label name and label description information input in the label creation area in response to an input operation in the label creation area, where the label description information describes the category label to be created; and display a first category label having a name of the label name and matching the label description information in the comment display area based on the label name and the label description information.

In some embodiments, the third display unit 1303 is configured to: semantically recognize the label name and the label description information to acquire the first category; determine a first comment from the plurality of comments displayed in the comment display area based on the first category, where the first comment belongs to the first category; and block comments other than the first comment from the comment display area.

In some embodiments, the third display unit 1303 is further configured to: in response to a trigger operation on the first category label, display a plurality of keywords in the comment display area based on a label name of the first category label; determine a second comment from the plurality of comments displayed in the comment display area in response to a selection operation on at least one keyword, where a correlation degree between the second comment and the at least one keyword is greater than a correlation degree threshold; and block comments other than the second comment from the comment display area.

In some embodiments, the third display unit 1303 is further configured to: in response to a trigger operation on the first category label, determine a third comment from the plurality of comments displayed in the comment display area based on a history comment associated with the first category label in a case that the first category label is the preset category label or the history category label, where the history comment is a comment belonging to the first category in a comment display area of another video work, and a similarity between the third comment and the history comment is greater than a similarity threshold; and block comments other than the third comment from the comment display area.

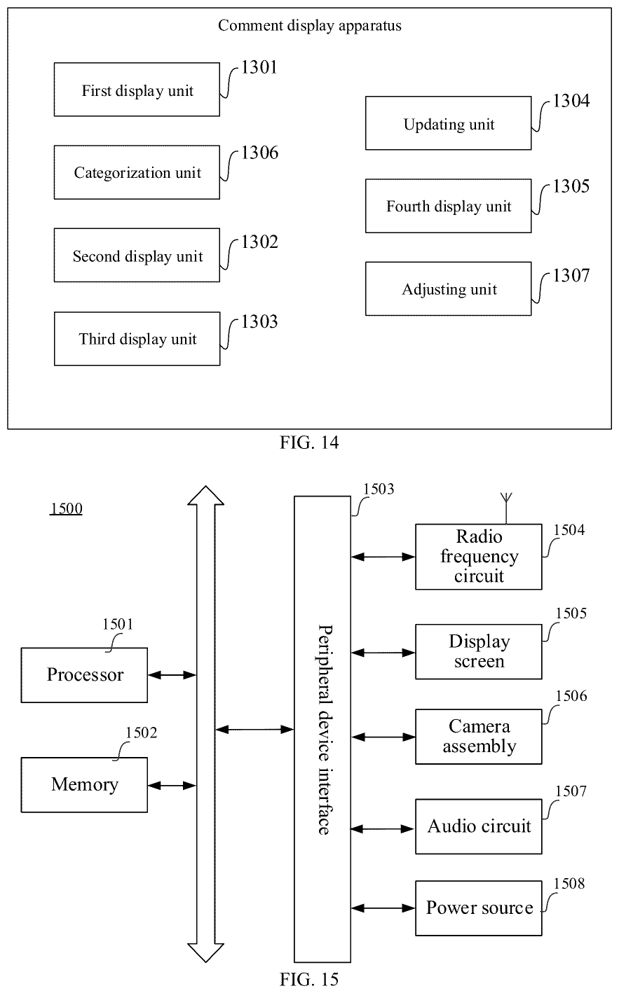

In some embodiments, FIG. 14 is a block diagram of another comment display apparatus according to an embodiment of the present disclosure. As shown in FIG. 14, the apparatus further includes an updating unit 1304 configured to update a type of the first category label from a private label type to a public label type in a case that a number of target accounts is greater than a number threshold, where the target accounts are accounts that have added the first category label in the comment display area, and the category label of the public label type indicates that the category label is visible to all accounts viewing the video work.

In some embodiments, the apparatus further includes a fourth display unit 1305 configured to display at least one of avatars or usernames of the target accounts in a target display style in response to the type of the first category label being updated to the public label type, where the target display style is configured to indicate that the category labels added by the target accounts are updated to the public label type.

In some embodiments, the apparatus further includes a categorization unit 1306 configured to: preprocess the comment to acquire a preprocessed comment for any comment on the video work, where the preprocessing is to remove punctuation, special symbols, and blank symbols from the comment; perform a word segmentation on the preprocessed comment to acquire a word segmentation result, where the word segmentation result includes a plurality of keywords appearing in the preprocessed comment; perform a sentiment polarity analysis on the preprocessed comment to acquire a sentiment polarity of the comment, where the sentiment polarity is positive, negative or neutral; and categorize the comment based on the word segmentation result and the sentiment polarity of the comment to acquire a category of the comment.

In some embodiments, the third display unit 1303 is further configured to: determine a comment belonging to a second category from the plurality of comments on the video work in response to a trigger operation on a second category label displayed in the comment display area, where the second category label is any category label displayed in the comment display area, and the second category is a category represented by the second category label; and display a comment belonging to the second category in the comment display area.

In some embodiments, the third display unit 1303 is further configured to: determine a display style associated with the second category label in response to the trigger operation on the second category label; and display the comment belonging to the second category in the comment display area in the display style associated with the second category label.

In some embodiments, the apparatus further includes: an adjusting unit 1307 configured to: adjust a display order of category labels in a comment display area of a next video work based on an interaction of a currently logged-in account with each of the category labels displayed in the comment display area, where the interaction is an interaction with a comment belonging to a category represented by the category label.

Embodiments of the present disclosure provide a comment display apparatus. Users are allowed to add category labels in the comment area of a video work on their own during the process of browsing the video work and commenting on the video work, and a terminal displays the category labels added by the users in the comment area. In the case that a category label is successfully added, the terminal determines and displays the comments belonging to the category represented by the category label, and the users can view the comments belonging to the category in the comment area, i.e., view the comments that the users are interested in without manually browsing the comments, thereby reducing the user's cost of viewing the comments and improving the human-computer interaction efficiency.

It is to be noted that the comment display apparatus provided in the above embodiments is only exemplified by the division of above functional units, and in actual application, the above functions may be assigned to be accomplished by different functional units according to the needs, that is, the internal structure of the electronic device is divided into different functional units to accomplish all or part of the above-described functions. In addition, the comment display apparatus provided in the above embodiments follows the same concept as the comment display method embodiments. For the specific implementation process, please refer to the method embodiments, which are not repeated herein.

Regarding the comment display apparatus in the above embodiments, the specific manner in which each module performs an operation has been described in detail in the related method embodiments, and are not described herein in detail.

FIG. 15 is a block diagram of an electronic device according to an embodiment of the present disclosure. Generally, the electronic device 1500 includes a processor 1501 and a memory 1502.

The processor 1501 includes one or more processing cores, such as a 4-core processor and an 8-core processor. The processor 1501 is implemented in at least one hardware form of a digital signal processor (DSP), a field programmable gate array (FPGA), and a programmable logic array (PLA). The processor 1501 also includes a main processor and a coprocessor. The main processor is a processor configured to process data in an awake state, and is also referred to as a central processing unit (CPU). The coprocessor is a low-power processor configured to process data in a standby state. In some embodiments, the processor 1501 is integrated with a graphics processing unit (GPU) that is responsible for rendering and drawing contents that need to be displayed on a display screen. In some other embodiments, the processor 1501 further includes an artificial intelligence (AI) processor for processing computing operations related to machine learning.

The memory 1502 includes one or more computer-readable storage media, which is non-transitory. The memory 1502 further includes a high-speed random access memory, and a non-volatile memory, such as one or more magnetic disk storage devices and flash storage devices. In some embodiments, a non-transitory computer-readable storage medium in the memory 1502 is configured to store at least one program code. The at least one program code is configured to be run by the processor 1501 to perform the page display method in the method embodiments.

In some embodiments, the electronic device 1500 further includes a peripheral device interface 1503 and at least one peripheral device. The processor 1501, the memory 1502, and the peripheral device interface 1503 are connected via buses or signal lines. The peripheral devices are connected to the peripheral device interface 1503 via a bus, signal line, or circuit board. The peripheral devices include at least one of a radio frequency circuit 1504, a display screen 1505, a camera assembly 1506, an audio circuit 1507, and a power source 1508.

The peripheral device interface 1503 is configured to connect at least one peripheral device associated with an input/output (I/O) to the processor 1501 and the memory 1502. In some embodiments, the processor 1501, the memory 1502, and the peripheral device interface 1503 are integrated on the same chip or circuit board. In some other embodiments, any one or two of the processor 1501, the memory 1502, and the peripheral device interface 1503 are implemented on a separate chip or circuit board, which is not limited in the embodiments of the present disclosure.

The radio frequency circuit 1504 is configured to receive and transmit a radio frequency (RF) signal, which is also referred to as an electromagnetic signal. The radio frequency circuit 1504 is communicated with a communication network and other communication devices via electromagnetic signals. The radio frequency circuit 1504 converts an electrical signal into an electromagnetic signal for transmission or converts a received electromagnetic signal into an electrical signal. In some embodiments, the radio frequency circuit 1504 includes an antenna system, an RF transceiver, one or more amplifiers, a tuner, an oscillator, a digital signal processor, a codec chipset, a subscriber identity module card, and the like. The radio frequency circuit 1504 is communicated with other terminals via at least one wireless communication protocol. The wireless communication protocol includes, but is not limited to, a metropolitan area network, various generations of mobile communication networks (2G, 3G, 4G, and 5G), a wireless local area network, and/or a wireless fidelity (Wi-Fi) network. In some embodiments, the radio frequency circuit 1504 further includes a near field communication (NFC) related circuit, which is not limited in the embodiments of the present disclosure.

The display screen 1505 is configured to display a user interface (UI). The UI includes graphics, text, icons, videos, and any combination thereof. In the case that the display screen 1505 is a touch display screen, the display screen 1505 also has the capacity to acquire a touch signal on or above a surface of the display screen 1505. The touch signal is input to the processor 1501 as a control signal for processing. In this case, the display screen 1505 is also configured to provide virtual buttons and/or virtual keyboards, which are also referred to as soft buttons and/or soft keyboards. In some embodiments, there may be one display screen 1505 and being arranged on a front panel of the electronic device 1500; in some other embodiments, there may be at least two display screens 1505 and being arranged on different surfaces of the electronic device 1500, respectively or in a folded design. In some still other embodiments, the display screen 1505 is a flexible display screen arranged on a curved surface or a folded surface of the electronic device 1500. Moreover, the display screen 1505 may have an irregular shape other than a rectangle, that is, an irregular-shaped screen. The display screen 1505 may be prepared by a material such as a liquid crystal display (LCD) or an organic light-emitting diode (OLED).

The camera assembly 1506 is configured to capture images or videos. In some embodiments, the camera component 1506 includes a front camera and a rear camera. Generally, the front camera is disposed on the front panel of the electronic device and the rear camera is disposed on a back side of the electronic device. In some embodiments, there are at least two rear cameras, and each of the at least two rear cameras is any one of a main camera, a depth-of-field camera, a wide-angle camera, and a telephoto camera, to realize a background blurring function realized by fusion of the main camera and the depth-of-field camera, panoramic shooting and virtual reality (VR) shooting functions by fusion of the main camera and the wide-angle camera, or other fusion shooting functions. In some embodiments, the camera component 1506 further includes a flash. The flash is a mono-color temperature flash or a two-color temperature flash. The two-color temperature flash is a combination of a warm-light flash and a cold-light flash, and can be used for light compensation at different color temperatures.

The audio circuit 1507 includes a microphone and a loudspeaker. The microphone is configured to acquire sound waves of the user and the environment, and convert the sound waves into electrical signals which are input into the processor 1501 for processing, or input into the radio frequency circuit 1504 for voice communication. For stereo collection or noise reduction, there are a plurality of microphones disposed at different parts of the electronic device 1500, respectively. The microphone is also an array microphone or an omnidirectional acquisition microphone. The loudspeaker is configured to convert the electrical signal from the processor 1501 or the radio frequency circuit 1504 into sound waves. The loudspeaker is a conventional film loudspeaker and is also a piezoelectric ceramic loudspeaker. In the case that the loudspeaker is a piezoelectric ceramic loudspeaker, the electrical signals can be converted into not only human-audible sound waves but also the sound waves that are inaudible to humans for ranging and the like. In some embodiments, the audio-frequency circuit 1507 further includes a headphone jack.

The power source 1508 is configured to supply power for various components in the electronic device 1500. The power source 1508 is an alternating current, a direct current, a disposable battery, or a rechargeable battery. In the case that the power source 1508 includes a rechargeable battery, the rechargeable battery is a wired charging battery or a wireless charging battery. The rechargeable battery also supports the fast charging technology.

Those skilled in the art can understand that the structure illustrated in FIG. 15 does not constitute a limitation of the electronic device 1500, and may include more or fewer components than illustrated, or a combination of certain components, or a different arrangement of components.

The embodiments of the present disclosure provide an electronic device, including:
one or more processors; and
a memory configured to store program codes executable by the one or more processors;
where the one or more processors are configured to execute the program codes to:
display a comment display area of a video work, where a plurality of comments on the video work are displayed in the comment display area;
display a newly-added first category label in the comment display area in response to a label adding operation; and
block comments that do not belong to a first category from the comment display area, where the first category is a category represented by the first category label.

In some embodiments, the one or more processors are configured to execute the program codes to: display a label adding interface in response to the label adding operation, where the label adding interface displays a plurality of preset category labels and a plurality of history category labels, the preset category labels are category labels in a category label library that are not displayed in the comment display area, and the history category labels are category labels that have been added by a currently logged-in account; and display the at least one category label as the first category label in the comment display area, in response to a selection operation on at least one category label displayed on the label adding interface.

In some embodiments, the label adding interface further displays a label creation area which is used to create a category label; and the one or more processors are configured to execute the program codes to: acquire a label name and label description information input in the label creation area in response to an input operation in the label creation area, where the label description information describes the category label to be created; and display a first category label having a name of the label name and matching the label description information in the comment display area based on the label name and the label description information.

In some embodiments, the one or more processors are configured to execute the program codes to: semantically recognize the label name and the label description information to acquire the first category; determine a first comment from the plurality of comments displayed in the comment display area based on the first category, where the first comment belongs to the first category; and block comments other than the first comment from the comment display area.

In some embodiments, the one or more processors are configured to execute the program codes to: display a plurality of keywords in the comment display area based on a label name of the first category label, in response to a trigger operation on the first category label; determine a second comment from the plurality of comments displayed in the comment display area in response to a selection operation on at least one keyword, where a correlation degree between the second comment and the at least one keyword is greater than a correlation degree threshold; and block comments other than the second comment from the comment display area.

In some embodiments, the one or more processors are configured to execute the program codes to: determine, in response to a trigger operation on the first category label, a third comment from the plurality of comments displayed in the comment display area based on a history comment associated with the first category label in a case that the first category label is the preset category label or the history category label, where the history comment is a comment belonging to the first category in a comment display area of another video work, and a similarity between the third comment and the history comment is greater than a similarity threshold; and block comments other than the third comment from the comment display area.

In some embodiments, the one or more processors are configured to execute the program codes to: update a type of the first category label from a private label type to a public label type in a case that a number of target accounts is greater than a number threshold, where the target accounts are accounts that have added the first category label in the comment display area, and the category label of the public label type indicates that the category label is visible to all accounts viewing the video work.

In some embodiments, the one or more processors are configured to execute the program codes to: display at least one of avatars or usernames of the target accounts in a target display style in response to the type of the first category label being updated to the public label type, where the target display style is configured to indicate that the category labels added by the target accounts are updated to the public label type.

In some embodiments, the one or more processors are configured to execute the program codes to: for any comment on the video work, preprocess the comment to acquire a preprocessed comment, where the preprocessing is to remove punctuation, special symbols, and blank symbols from the comment; perform a word segmentation on the preprocessed comment to acquire a word segmentation result, where the word segmentation result includes a plurality of keywords appearing in the preprocessed comment; perform a sentiment polarity analysis on the preprocessed comment to acquire a sentiment polarity of the comment, where the sentiment polarity is positive, negative or neutral; and categorize the comment based on the word segmentation result and the sentiment polarity of the comment to acquire a category of the comment.

In some embodiments, the one or more processors are configured to execute the program codes to: determine a comment belonging to a second category from the plurality of comments on the video work in response to a trigger operation on a second category label displayed in the comment display area, where the second category label is any category label displayed in the comment display area, and the second category is a category represented by the second category label; and display a comment belonging to the second category in the comment display area.

In some embodiments, the one or more processors are configured to execute the program codes to: determine a display style associated with the second category label in response to the trigger operation on the second category label; and display the comment belonging to the second category in the comment display area in the display style associated with the second category label.

In some embodiments, the one or more processors are configured to execute the program codes to: adjust a display order of category labels in a comment display area of a next video work based on an interaction of a currently logged-in account with each of the category labels displayed in the comment display area, where the interaction is an interaction with a comment belonging to a category represented by the category label.

In some example embodiments, a computer-readable storage medium including instructions is further provided, such as a memory 1502 including instructions. The instructions, when executed by the processor 1501 of the electronic device 1500, are caused to perform the aforementioned comment display method. In some embodiments, the computer-readable storage medium is a ROM, a random access memory (RAM), a CD-ROM, a magnetic tape, a floppy disk, an optical data storage device, and the like.

The embodiments of the present disclosure further provide a computer-readable storage medium. The instructions in the computer-readable storage medium, when executed by a processor of an electronic device, cause the electronic device to:
display a comment display area of a video work, where a plurality of comments on the video work are displayed in the comment display area;
display a newly-added first category label in the comment display area in response to a label adding operation; and
block comments that do not belong to a first category from the comment display area, where the first category is a category represented by the first category label.

In some embodiments, the processor is configured to execute the instructions to: display a label adding interface in response to the label adding operation, where the label adding interface displays a plurality of preset category labels and a plurality of history category labels, the preset category labels are category labels in a category label library that are not displayed in the comment display area, and the history category labels are category labels that have been added by a currently logged-in account; and display the at least one category label as the first category label in the comment display area, in response to a selection operation on at least one category label displayed on the label adding interface.

In some embodiments, the label adding interface further displays a label creation area which is used to create a category label; and the processor is configured to execute the instructions to: acquire a label name and label description information input in the label creation area in response to an input operation in the label creation area, where the label description information describes the category label to be created; and display a first category label having a name of the label name and matching the label description information in the comment display area based on the label name and the label description information.

In some embodiments, the processor is configured to execute the instructions to: semantically recognize the label name and the label description information to acquire the first category; determine a first comment from the plurality of comments displayed in the comment display area based on the first category, where the first comment belongs to the first category; and block comments other than the first comment from the comment display area.

In some embodiments, the processor is configured to execute the instructions to: display a plurality of keywords in the comment display area based on a label name of the first category label in response to a trigger operation on the first category label; determine a second comment from the plurality of comments displayed in the comment display area in response to a selection operation on at least one keyword, where a correlation degree between the second comment and the at least one keyword is greater than a correlation degree threshold; and block comments other than the second comment from the comment display area.

In some embodiments, the processor is configured to execute the instructions to: determine, in response to a trigger operation on the first category label, a third comment from the plurality of comments displayed in the comment display area based on a history comment associated with the first category label in a case that the first category label is the preset category label or the history category label, where the history comment is a comment belonging to the first category in a comment display area of another video work, and a similarity between the third comment and the history comment is greater than a similarity threshold; and block comments other than the third comment from the comment display area.

In some embodiments, the processor is configured to execute the instructions to: update a type of the first category label from a private label type to a public label type in a case that a number of target accounts is greater than a number threshold, where the target accounts are accounts that have added the first category label in the comment display area, and the category label of the public label type indicates that the category label is visible to all accounts viewing the video work.

In some embodiments, the processor is configured to execute the instructions to: display at least one of avatars or usernames of the target accounts in a target display style in response to the type of the first category label being updated to the public label type, where the target display style is configured to indicate that the category labels added by the target accounts are updated to the public label type.

In some embodiments, the processor is configured to execute the instructions to: for any comment on the video work, preprocess the comment to acquire a preprocessed comment, where the preprocessing is to remove punctuation, special symbols, and blank symbols from the comment; perform a word segmentation on the preprocessed comment to acquire a word segmentation result, where the word segmentation result includes a plurality of keywords appearing in the preprocessed comment; perform a sentiment polarity analysis on the preprocessed comment to acquire a sentiment polarity of the comment, where the sentiment polarity is positive, negative or neutral; and categorize the comment based on the word segmentation result and the sentiment polarity of the comment to acquire a category of the comment.

In some embodiments, the processor is configured to execute the instructions to: determine a comment belonging to a second category from the plurality of comments on the video work in response to a trigger operation on a second category label displayed in the comment display area, where the second category label is any category label displayed in the comment display area, and the second category is a category represented by the second category label; and display a comment belonging to the second category in the comment display area.

In some embodiments, the processor is configured to execute the instructions to: determine a display style associated with the second category label in response to the trigger operation on the second category label; and display the comment belonging to the second category in the comment display area in the display style associated with the second category label.

In some embodiments, the processor is configured to execute the instructions to: adjust a display order of category labels in a comment display area of a next video work based on an interaction of a currently logged-in account with each of the category labels displayed in the comment display area, where the interaction is an interaction with a comment belonging to a category represented by the category label.

In some example embodiments, a computer program product is provided. The computer program product includes computer programs that, when executed by a processor, are caused to:
display a comment display area of a video work, where a plurality of comments on the video work are displayed in the comment display area;
display a newly-added first category label in the comment display area in response to a label adding operation; and
block comments that do not belong to a first category from the comment display area, where the first category is a category represented by the first category label.

In some embodiments, the processor is configured to execute the computer programs to: display a label adding interface in response to the label adding operation, where the label adding interface displays a plurality of preset category labels and a plurality of history category labels, the preset category labels are category labels in a category label library that are not displayed in the comment display area, and the history category labels are category labels that have been added by a currently logged-in account; and display the at least one category label as the first category label in the comment display area, in response to a selection operation on at least one category label displayed on the label adding interface.

In some embodiments, the label adding interface further displays a label creation area which is used to create a category label; and the processor is configured to execute the computer programs to: acquire a label name and label description information input in the label creation area in response to an input operation in the label creation area, where the label description information describes the category label to be created; and display a first category label having a name of the label name and matching the label description information in the comment display area based on the label name and the label description information.

In some embodiments, the processor is configured to execute the computer programs to: semantically recognize the label name and the label description information to acquire the first category; determine a first comment from the plurality of comments displayed in the comment display area based on the first category, where the first comment belongs to the first category; and block comments other than the first comment from the comment display area.

In some embodiments, the processor is configured to execute the computer programs to: display a plurality of keywords in the comment display area based on a label name of the first category label, in response to a trigger operation on the first category label; determine a second comment from the plurality of comments displayed in the comment display area in response to a selection operation on at least one keyword, where a correlation degree between the second comment and the at least one keyword is greater than a correlation degree threshold; and block comments other than the second comment from the comment display area.

In some embodiments, the processor is configured to execute the computer programs to: determine, in response to a trigger operation on the first category label, a third comment from the plurality of comments displayed in the comment display area based on a history comment associated with the first category label in a case that the first category label is the preset category label or the history category label, where the history comment is a comment belonging to the first category in a comment display area of another video work, and a similarity between the third comment and the history comment is greater than a similarity threshold; and block comments other than the third comment from the comment display area.

In some embodiments, the processor is configured to execute the computer programs to: update a type of the first category label from a private label type to a public label type in a case that a number of target accounts is greater than a number threshold, where the target accounts are accounts that have added the first category label in the comment display area, and the category label of the public label type indicates that the category label is visible to all accounts viewing the video work.

In some embodiments, the processor is configured to execute the computer programs to: display at least one of avatars or usernames of the target accounts in a target display style in response to the type of the first category label being updated to the public label type, where the target display style is configured to indicate that the category labels added by the target accounts are updated to the public label type.

In some embodiments, the processor is configured to execute the computer programs to: for any comment on the video work, preprocess the comment to acquire a preprocessed comment, where the preprocessing is to remove punctuation, special symbols, and blank symbols from the comment; perform a word segmentation on the preprocessed comment to acquire a word segmentation result, where the word segmentation result includes a plurality of keywords appearing in the preprocessed comment; perform a sentiment polarity analysis on the preprocessed comment to acquire a sentiment polarity of the comment, where the sentiment polarity is positive, negative or neutral; and categorize the comment based on the word segmentation result and the sentiment polarity of the comment to acquire a category of the comment.

In some embodiments, the processor is configured to execute the computer programs to: determine a comment belonging to a second category from the plurality of comments on the video work in response to a trigger operation on a second category label displayed in the comment display area, where the second category label is any category label displayed in the comment display area, and the second category is a category represented by the second category label; and display a comment belonging to the second category in the comment display area.

In some embodiments, the processor is configured to execute the computer programs to: determine a display style associated with the second category label in response to the trigger operation on the second category label; and display the comment belonging to the second category in the comment display area in the display style associated with the second category label.

In some embodiments, the processor is configured to execute the computer programs to: adjust a display order of category labels in a comment display area of a next video work based on an interaction of a currently logged-in account with each of the category labels displayed in the comment display area, where the interaction is an interaction with a comment belonging to a category represented by the category label.

All of the embodiments of the present disclosure may be implemented individually or in combinations, all of which shall be within the protection scope of the present disclosure.

What is claimed is:

1. A comment display method, comprising:
displaying a comment display area of a video work, wherein a plurality of comments on the video work are displayed in the comment display area;
adding to the comment display area and displaying a first category label in the comment display area in response to a label adding operation; and
blocking comments that do not belong to a first category from the comment display area, wherein the first category is a category represented by the first category label.

2. The comment display method according to claim 1, wherein the displaying the first category label in the comment display area in response to the label adding operation comprises:
displaying a label adding interface in response to the label adding operation, wherein the label adding interface displays a plurality of preset category labels and a plurality of history category labels, the plurality of preset category labels are category labels in a category label library that are not displayed in the comment display area, and the plurality of history category labels are category labels that have been added by a currently logged-in account; and
displaying, in response to a selection operation on at least one category label displayed on the label adding interface, the at least one category label as the first category label in the comment display area.

3. The comment display method according to claim 2, wherein the label adding interface further displays a label creation area which is configured to create a category label; and wherein the method further comprises:
acquiring a label name and label description information input in the label creation area in response to an input operation in the label creation area, wherein the label description information describes a category label to be created; and
displaying the first category label having a name of the label name and matching the label description information in the comment display area based on the label name and the label description information.

4. The comment display method according to claim 3, wherein the blocking the comments that do not belong to the first category from the comment display area comprises:
semantically recognizing the label name and the label description information to acquire the first category;
determining a first comment from the plurality of comments displayed in the comment display area based on the first category, wherein the first comment belongs to the first category; and
blocking comments other than the first comment from the comment display area.

5. The comment display method according to claim 1, wherein the blocking the comments that do not belong to the first category from the comment display area comprises:
displaying a plurality of keywords in the comment display area based on a label name of the first category label, in response to a trigger operation on the first category label;
determining a second comment from the plurality of comments displayed in the comment display area in response to a selection operation on at least one keyword, wherein a correlation degree between the second comment and the at least one keyword is greater than a correlation degree threshold; and
blocking comments other than the second comment from the comment display area.

6. The comment display method according to claim 2, wherein the blocking the comments that do not belong to the first category from the comment display area comprises:
determining a third comment from the plurality of comments displayed in the comment display area based on a history comment associated with the first category label in response to a trigger operation on the first category label, in a case that the first category label is a preset category label or a history category label, wherein the history comment is a comment belonging to the first category in a comment display area of another video work, and a similarity between the third comment and the history comment is greater than a similarity threshold; and
blocking comments other than the third comment from the comment display area.

7. The comment display method according to claim 1, further comprising:
updating a type of the first category label from a private label type to a public label type in a case that a number of target accounts is greater than a number threshold, wherein the target accounts are accounts that have added the first category label in the comment display area, and the public label type indicates that a category label is visible to all accounts viewing the video work.

8. The comment display method according to claim 7, further comprising:
displaying at least one of avatars or usernames of the target accounts in a target display style in response to the type of the first category label being updated to the public label type, wherein the target display style is configured to indicate that category labels added by the target accounts are updated to the public label type.

9. The comment display method according to claim 1, further comprising:
for any comment on the video work, preprocessing the comment to acquire a preprocessed comment, wherein the preprocessing is to remove punctuation, special symbols, and blank symbols from the comment;
performing a word segmentation on the preprocessed comment to acquire a word segmentation result, wherein the word segmentation result comprises a plurality of keywords appearing in the preprocessed comment;
performing a sentiment polarity analysis on the preprocessed comment to acquire a sentiment polarity of the comment, wherein the sentiment polarity is positive, negative or neutral; and
categorizing the comment based on the word segmentation result and the sentiment polarity of the comment to acquire a category of the comment.

10. The comment display method according to claim 1, further comprising:
determining a comment belonging to a second category from the plurality of comments on the video work in response to a trigger operation on a second category label displayed in the comment display area, wherein the second category label is any category label displayed in the comment display area, and the second category is a category represented by the second category label; and
displaying a comment belonging to the second category in the comment display area.

11. The comment display method according to claim 10, wherein the displaying the comment belonging to the second category in the comment display area comprises:
determining a display style associated with the second category label in response to the trigger operation on the second category label; and
displaying the comment belonging to the second category in the comment display area in the display style associated with the second category label.

12. The comment display method according to claim 1, further comprising:
adjusting a display order of category labels in a comment display area of a next video work based on an interaction of a currently logged-in account with each of category labels displayed in the comment display area, wherein the interaction is an interaction with a comment belonging to a category represented by the first category label.

13. An electronic device, comprising:
one or more processors; and
a memory configured to store program codes executable by the one or more processors;
wherein the one or more processors are configured to execute the program codes to:
display a comment display area of a video work, wherein a plurality of comments on the video work are displayed in the comment display area;
add to the comment display area and display a first category label in the comment display area in response to a label adding operation; and
block comments that do not belong to a first category from the comment display area, wherein the first category is a category represented by the first category label.

14. The electronic device according to claim 13, wherein the one or more processors are configured to execute the program codes to:
display a label adding interface in response to the label adding operation, wherein the label adding interface displays a plurality of preset category labels and a plurality of history category labels, the plurality of preset category labels are category labels in a category label library that are not displayed in the comment display area, and the plurality of history category labels are category labels that have been added by a currently logged-in account; and
display, in response to a selection operation on at least one category label displayed on the label adding interface, the at least one category label as the first category label in the comment display area.

15. The electronic device according to claim 14, wherein the label adding interface further displays a label creation area which is configured to create a category label; and the one or more processors are configured to execute the program codes to:
acquire a label name and label description information input in the label creation area in response to an input operation in the label creation area, wherein the label description information describes a category label to be created; and
display the first category label having a name of the label name and matching the label description information in the comment display area based on the label name and the label description information.

16. The electronic device according to claim 15, wherein the one or more processors are configured to execute the program codes to:
semantically recognize the label name and the label description information to acquire the first category;
determine a first comment from the plurality of comments displayed in the comment display area based on the first category, wherein the first comment belongs to the first category; and
block comments other than the first comment from the comment display area.

17. The electronic device according to claim 14, wherein the one or more processors are configured to execute the program codes to:
display a plurality of keywords in the comment display area based on a label name of the first category label, in response to a trigger operation on the first category label;
determine a second comment from the plurality of comments displayed in the comment display area in response to a selection operation on at least one keyword, wherein a correlation degree between the second comment and the at least one keyword is greater than a correlation degree threshold; and
block comments other than the second comment from the comment display area.

18. The electronic device according to claim 14, wherein the one or more processors are configured to execute the program codes to:
determine a third comment from the plurality of comments displayed in the comment display area based on a history comment associated with the first category label in response to a trigger operation on the first category label, in a case that the first category label is a preset category label or a history category label, wherein the history comment is a comment belonging to the first category in a comment display area of another video work, and a similarity between the third comment and the history comment is greater than a similarity threshold; and
block comments other than the third comment from the comment display area.

19. The electronic device according to claim 13, wherein the one or more processors are configured to execute the program codes to:
update a type of the first category label from a private label type to a public label type in a case that a number of target accounts is greater than a number threshold, wherein the target accounts are accounts that have added the first category label in the comment display area, and the public label type indicates that a category label is visible to all accounts viewing the video work.

20. A non-transitory computer-readable storage medium comprising instructions therein, wherein the instructions, when executed by a processor of an electronic device, cause the electronic device to:
display a comment display area of a video work, wherein a plurality of comments on the video work are displayed in the comment display area;
add to the comment display area and display a first category label in the comment display area in response to a label adding operation; and
block comments that do not belong to a first category from the comment display area, wherein the first category is a category represented by the first category label.
